(19) United States
(12) Patent Application Publication
(10) Pub. No.: US 2026/0235296 A1
(43) Pub. Date: Aug. 13, 2026

(54) COOKING APPARATUS AND CONTROL METHOD THEREOF

(71) Applicant: SAMSUNG ELECTRONICS CO., LTD., Suwon-si (KR)

(72) Inventors: Seulkee LEE, Suwon-si (KR); Hwan CHANG, Suwon-si (KR); Kumchul HWANG, Suwon-si (KR)

(73) Assignee: SAMSUNG ELECTRONICS CO., LTD., Suwon-si (KR)

(21) Appl. No.: 19/639,982

(22) Filed: Apr. 6, 2026

Related U.S. Application Data
(63) Continuation of application No. PCT/KR2024/016225, filed on Oct. 24, 2024.

(30) Foreign Application Priority Data
Nov. 6, 2023 (KR) 10-2023-0152182

(51) Int. Cl. F24C 7/08; F24C 15/20

(52) U.S. Cl. CPC F24C 7/085; F24C 7/087; F24C 15/2007

(57) ABSTRACT

A cooking apparatus includes a cooking chamber configured to accommodate a container containing food and water, a thermal imaging sensor configured to obtain a thermal image of the container accommodated in the cooking chamber, a heating portion configured to heat the food, a fan configured to discharge steam from the cooking chamber to prevent a temperature of the cooking chamber from decreasing, and a processor configured to monitor a temperature change in the container based on the thermal image of the container, and control at least one of the fan and the heating portion based on the monitored temperature change in the container. The cooking apparatus determines whether water is insufficient in the container, and outputs a water shortage notification based on determining that water is insufficient, thereby allowing a user to add water to the container.

### CROSS REFERENCE TO THE RELATED APPLICATION

This application is a continuation application, filed under 35 U.S.C. § 111(a), of International Application PCT/KR2024/016225, filed on Oct. 24, 2024, and is based on and claims priority under 35 U.S.C. § 119 to Korean Patent Applications No. 10-2023-0152182, filed on Nov. 6, 2023 in the Korean Intellectual Property Office, the disclosures of which are incorporated by reference herein in their entireties.

### TECHNICAL FIELD

The disclosure relates to a cooking apparatus detecting a temperature of food and controlling a cooking operation based on the detected temperature of the food, and a method for controlling the cooking apparatus.

### BACKGROUND ART

In general, a cooking apparatus is an appliance for heating and cooking food, and is largely divided into a method of using electricity to generate heat for heating food and a method of burning gas to generate heat for heating food. For example, the cooking apparatus may be classified into a gas stove, an oven, an induction heater, a highlight, and a microwave oven.

For each type of cooking apparatus, a container and a recipe suitable for the cooking method are determined according to a method of heating food. Cooking food using an unsuitable recipe may deteriorate the cooking quality of the food or cause user inconvenience.

For example, in the case of sous-vide cooking using an oven, a cooking chamber is filled with steam, and cooking takes a long time because water is heated by hot air.

As another example, in the case of sous-vide cooking using a gas stove or an induction heater, food may float in the water due to convection in the water, or the amount of water in the container may become insufficient due to evaporation. As a result, the food may be exposed above the water, thereby deteriorating the cooking quality of the food.

### DISCLOSURE

### Technical Problem

An embodiment of the disclosure provides a cooking apparatus that may determine whether food is exposed above a surface of water in a container based on a thermal image and output a water shortage notification, and a method for controlling the same.

Another embodiment of the disclosure provides a cooking apparatus that may control steam discharge based on a thermal image, and a method for controlling the same.

### Technical Solution

According to an embodiment of the disclosure, a cooking apparatus may include: a cooking chamber configured to accommodate a container containing food and water; a thermal imaging sensor configured to obtain a thermal image of the container accommodated in the cooking chamber; a heating portion configured to heat the food; a fan configured to discharge steam from the cooking chamber; and a processor configured to identify a temperature change of the container based on the thermal image of the container, and control at least one of the fan and the heating portion based on the identified temperature change of the container.

According to an embodiment of the disclosure, the thermal image of the container includes at least one of a thermal image of a surface of the water contained in the container or a thermal image of a surface of the food contained in the container.

According to an embodiment of the disclosure, the processor of the cooking apparatus may be further configured to control the fan to be turned on based on the identified temperature change being greater than or equal to a reference value.

According to an embodiment of the disclosure, the processor of the cooking apparatus may be further configured to: based on identifying that the identified temperature change being greater than or equal to a reference value, is maintained during a defined time, control the fan to be turned on, and control the heating portion to increase an output of the heating portion based on the fan being turned on.

According to an embodiment of the disclosure, the processor of the cooking apparatus may be further configured to obtain a first temperature of the container immediately before the fan is turned on, obtain a second temperature of the container while the fan is turned on, and control the fan to be turned off based on the obtained second temperature reaching the first temperature.

According to an embodiment of the disclosure, the processor of the cooking apparatus may be further configured to: control the output of the heating portion, which has been increased based on the fan being turned on, to be restored based on the fan being turned off.

According to an embodiment of the disclosure, the processor of the cooking apparatus may be further configured to obtain a temperature of each of a plurality of areas of the container; and identify a water shortage, based on temperatures of a portion of the plurality of areas being different from temperatures of remaining areas.

According to an embodiment of the disclosure, the processor of the cooking apparatus may be further configured to: identify a cooking operation time which is a time duration from a time of turning-on the heating portion to a time identifying that the temperatures of the portion of the plurality of areas being different from the temperatures of the remaining areas, and based on the identified cooking operation time being less than a reference time, identify an occurrence of abnormal state. The reference time is an expected time duration from the time of turning-on the heating portion to a time at which the steam begins to form.

According to an embodiment of the disclosure, the cooking apparatus may further include at least one of an output portion and communication circuitry configured to communicate with an external apparatus. The processor may be further configured to: control the output portion to output corresponding to the water shortage, or control the communication circuitry to transmit signal corresponding to the water shortage to the external apparatus.

According to an embodiment of the disclosure, the processor may be configured to: identify a water shortage based on a difference between a change of the temperature of an area of the container and a remaining area which is not the area of the container in the obtained thermal image.

According to another embodiment of the disclosure, a method for controlling a cooking apparatus including a cooking chamber, a thermal imaging sensor, a heating portion, a fan and a processor, the method comprising: identifying a temperature change of a container accommodated in the cooking chamber based on a thermal image obtained by the thermal imaging sensor, the container containing food and water; and controlling at least one of the fan and the heating portion based on the identified temperature change in the container.

According to an embodiment of the disclosure, the thermal image of the container includes at least one of a thermal image of a surface of the water contained in the container or a thermal image of a surface of the food contained in the container.

The controlling of the fan may include controlling the fan to be turned on based on the identified temperature change being greater than or equal to a reference value.

The controlling of the fan may include controlling the fan to be turned on, based on identifying that the identified temperature change being greater than or equal to the reference value, is maintained during a defined time, and controlling the fan to be turned off, is not maintained during the defined time. The controlling of the heating portion comprises controlling the heating portion to increase an output of the heating portion based on the fan being turned on.

The controlling of the fan may include obtaining a first temperature of the container immediately before the fan is turned on, obtaining a second temperature of the container while the fan is turned on; and controlling the fan to be turned off based on the obtained second temperature reaching the first temperature.

The controlling of the heating may include: controlling an output of the heating portion, which has been increased based on the fan being turned on, to be restored based on the fan being turned off.

The method may further include: obtaining a temperature of each of a plurality of areas of the container, and identifying a water shortage, based on temperatures of a portion of the plurality of areas being different from temperatures of remaining areas.

The method may further include: identifying a cooking operation time which is a time duration from a time of turning-on the heating portion to a time identifying that the temperatures of the portion of the plurality of areas being different from the temperatures of the remaining areas, and based on the identified cooking operation time being less than a reference time, identifying an occurrence of abnormal state. The reference time is an expected time duration from the time of turning-on the heating portion to a time at which the steam begins to form.

The method may further include: controlling an output portion to output corresponding to the water shortage, or controlling communication circuitry to transmit signal corresponding to the water shortage to an external apparatus.

The method may further include: identifying a water shortage based on a difference between a change of the temperature of an area of the container and a remaining area which is not the area of the container in the obtained thermal image.

### Advantageous Effects

According to the disclosure, while detecting a temperature of a container in a cooking chamber using a thermal image, a fan may be controlled to discharge steam generated within the cooking chamber, thereby accurately detecting the temperature of the container for sous-vide cooking.

As such, by accurately detecting the temperature of the container for sous-vide cooking, an output of a heating portion may be precisely controlled.

According to the disclosure, when food in a container is exposed above a water surface, a water shortage notification may be output, thereby allowing a user to recognize a water shortage in the container. That is, in the case of water shortage, the user may easily recognize the water shortage without opening a door of the cooking apparatus. Accordingly, user convenience may be improved.

When water is insufficient in the container, the food may be submerged in water again as water is added by the user, and thus the quality of sous-vide cooking may be improved. By improving the quality of sous-vide cooking, user satisfaction may also be improved.

According to the disclosure, the quality and marketability of the cooking apparatus may be improved, and safety and competitiveness of the cooking apparatus may be enhanced.

### DESCRIPTION OF DRAWINGS

FIG. 1 illustrates an example of a home network system including a home appliance according to an embodiment.

FIG. 2 is an external view of a cooking apparatus according to an embodiment.

FIG. 3 is a view illustrating an example in which a door of a cooking apparatus according to an embodiment is open.

FIG. 4 is a view illustrating an example arrangement of a container and a thermal imaging sensor of a cooking apparatus according to an embodiment.

FIG. 5 is a control block diagram of a cooking apparatus according to an embodiment.

FIG. 6A is a view illustrating an example of a thermal image obtained by a thermal imaging sensor of a cooking apparatus according to an embodiment.

FIG. 6B is a view illustrating an example of temperatures obtained by a thermal image of a cooking apparatus according to an embodiment.

FIG. 6C is a view illustrating an example of a temperature for each area of a container placed in a cooking apparatus according to an embodiment.

FIG. 7 is a view illustrating an example of temperatures obtained by a thermal image after steam is discharged from a cooking apparatus according to an embodiment.

FIG. 8 is a view illustrating an example of temperatures obtained by a thermal image, when food is partially exposed above a water surface in a container after steam is discharged from a cooking apparatus according to an embodiment.

FIG. 9 is a view illustrating an example of temperatures obtained by a thermal image, when food is fully exposed above a water surface in a container after steam is discharged from a cooking apparatus according to an embodiment.

FIG. 10 is a flowchart illustrating a method for controlling a cooking apparatus according to an embodiment.

FIG. 11 is a flowchart illustrating a method for controlling a fan and a heating portion of a cooking apparatus according to an embodiment

FIG. 12 is a flowchart illustrating operations of determining whether water is insufficient in a cooking apparatus according to an embodiment.

FIG. 13 is a control block diagram of a cooking apparatus according to another embodiment.

### MODES OF THE INVENTION

Various embodiments of the disclosure and terms used herein are not intended to limit the technical features described herein to specific embodiments, and should be understood to include various modifications, equivalents, or substitutions of the corresponding embodiments.

In describing of the drawings, similar reference numerals may be used for similar or related elements.

The singular form of a noun corresponding to an item may include one or more of the items unless clearly indicated otherwise in a related context.

In the disclosure, phrases, such as “A or B”, “at least one of A and B”, “at least one of A or B”, “A, B or C”, “at least one of A, B and C”, and “at least one of A, B, or C” may include any one or all possible combinations of the items listed together in the corresponding phrase among the phrases.

Terms such as “1st”, “2nd”, “primary”, or “secondary” may be used simply to distinguish an element from other elements, without limiting the element in other embodiments (e.g., importance or order).

When an element (e.g., a first element) is referred to as being “(functionally or communicatively) coupled” or “connected” to another element (e.g., a second element), the first element may be connected to the second element, directly (e.g., wired), wirelessly, or through a third element.

It will be understood that when the terms “includes”, “comprises”, “including”, and/or “comprising” are used in the disclosure, they specify the presence of the specified features, figures, steps, operations, components, members, or combinations thereof, but do not preclude the presence or addition of one or more other features, figures, steps, operations, components, members, or combinations thereof.

When a given element is referred to as being “connected to”, “coupled to”, “supported by” or “in contact with” another element, it is to be understood that it may be directly or indirectly connected to, coupled to, supported by, or in contact with the other element. When a given element is indirectly connected to, coupled to, supported by, or in contact with another element, it is to be understood that it may be connected to, coupled to, supported by, or in contact with the other element through a third element.

It will also be understood that when an element is referred to as being “on” another element, it may be directly on the other element or intervening elements may also be present.

As used herein, the term “and/or” includes any and all combinations of one or more of the associated listed items.

Hereinafter, the principles of operation and embodiments of the disclosure will be described with reference to the accompanying drawings.

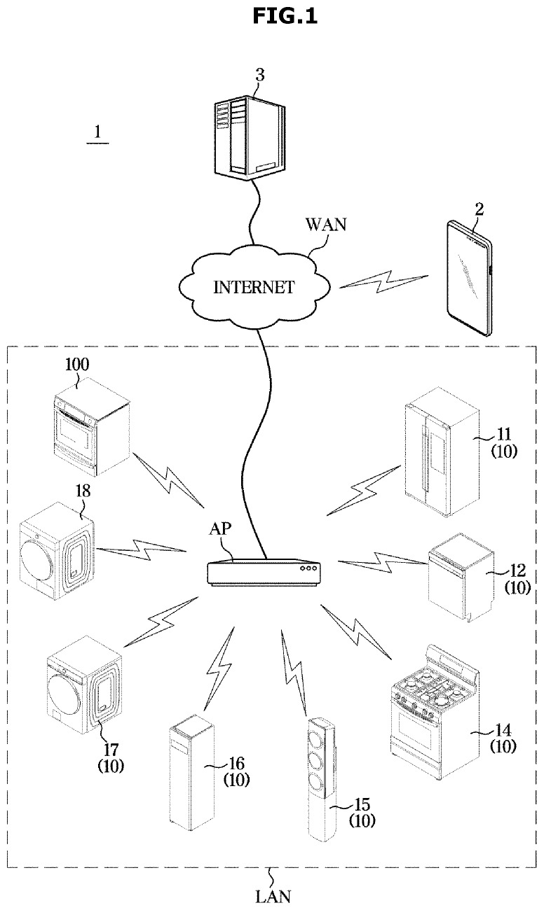

FIG. 1 illustrates an example of a home network system including a home appliance according to an embodiment.

A home network system 1 includes a home appliance 10, a user device 2 and a server 3. A home appliance 10 may include a communication module capable of communicating with another home appliance, a user device 2, or a server 3, a user interface that receives a user input or outputs information to a user, at least one processor that controls an operation of the home appliance 10, and at least one memory that stores a program for controlling the operation of the home appliance 10.

The home appliance 10 may be at least one of various types of home appliances. For example, as shown in the accompanying drawings, the home appliance 10 may include a refrigerator 11, a dishwasher 12, a gas stove 14, an air conditioner 15, a clothes treating apparatus 16, a washing machine 17, a dryer 18, or a cooking apparatus 100, but is not limited thereto. For example, the home appliance 10 may include various types of appliances not shown in the drawings, such as a cleaning robot, a vacuum cleaner, a television, and the like. Furthermore, the aforementioned home appliances are by way of example only, and in addition to the aforementioned home appliances, other appliances connected to other home appliance, the user device 2, or the server 3 to perform operations described below may be included in the home appliance 10 according to an embodiment.

The server 3 may include a communication module communicating with another server, the home appliance 10, or the user device 2, at least one processor that processes data received from another server, the home appliance 10, or the user device 2, and at least one memory that stores programs for processing data or processed data.

The server 3 may be implemented as a variety of computing devices, such as a workstation, a cloud, a data drive, a data station, and the like. The server 3 may be implemented as one or more server physically or logically separated based on a function, detailed configuration of function, or data, and may transmit and receive data through communication between servers and process the transmitted and received data.

The server 3 may perform functions, such as managing a user account, registering the home appliance 10 in association with the user account, managing or controlling the registered home appliance 10, and the like. For example, a user may access the server 3 via the user device 2 and may create a user account. The user account may be identified by an identifier (ID) and a password set by the user.

The server 3 may register the home appliance 10 with the user account according to a predetermined procedure. For example, the server 3 may link identification information of the home appliance 10 (e.g., a serial number or MAC address) to the user account to register, manage, and control the home appliance 10.

The user device 2 may include a communication module capable of communicating with the home appliance 10 or the server 3, a user interface that receives a user input or outputs information to a user, at least one processor that controls an operation of the user device 2, and at least one memory that stores a program for controlling the operation of the user device 2.

The user device 2 may be carried by a user, or placed in a user's home or office, or the like. The user device 2 may include a personal computer (PC), a terminal, a portable telephone, a smartphone, a handheld device, a wearable device, and the like, but is not limited thereto.

The memory of the user device 2 may store a program for controlling the home appliance 10, i.e. an application. The application may be sold installed on the user device 2, or may be downloaded from an external server for installation.

By running the application installed on the user device 2 by a user, the user may access the server 3, create a user account, and communicate with the server 3 based on the login user account to register the home appliance 10.

For example, by operating the home appliance 10 to allow the home appliance 10 to access the server 3 according to a procedure guided by the application installed on the user device 2, the server 3 may register the home appliance 10 with the user account by assigning the identification information (e.g., a serial number or a MAC address) of the home appliance 10 to the corresponding user account.

A user may control the home appliance 10 using the application installed on the user device 2. For example, by logging into a user account with the application installed on the user device 2, the home appliance 10 registered in the user account appears, and by inputting a control command for the home appliance 10, the control command may be delivered to the home appliance 10 via the server 3.

A network may include both a wired network and a wireless network. The wired network may include a cable network or a telephone network, and the wireless network may include any networks transmitting and receiving a signal via radio waves. The wired network and the wireless network may be interconnected.

The network may include a wide area network (WAN), such as the Internet, a local area network (LAN) formed around an access point (AP), and a short-range wireless network that does not use an AP. The short-range wireless network may include Bluetooth™ (IEEE 802.15.1), Zigbee (IEEE 802.15.4), Wi-Fi Direct, near field communication (NFC), and Z-Wave, but is not limited thereto.

The AP may connect the home appliance 10 or the user device 2 to a WAN connected to the server 3. The home appliance 10 or the user device 2 may be connected to the server 3 via a WAN.

The AP may communicate with the home appliance 10 or the user device 2 using wireless communication, such as Wi-Fi™ (IEEE 802.11), Bluetooth™ (IEEE 802.15.1), Zigbee (IEEE 802.15.4), and the like, and access a WAN using wired communication, but is not limited thereto.

According to various embodiments, the home appliance 10 may be directly connected to the user device 2 or the server 3 without going through an AP.

The home appliance 10 may be connected to the user device 2 or the server 3 via a long-range wireless network or a short-range wireless network.

For example, the home appliance 10 may be connected to the user device 2 via a short-range wireless network (e.g., Wi-Fi Direct).

In another example, the home appliance 10 may be connected to the user device 2 or the server 3 via a WAN using a long-range wireless network (e.g., a cellular communication module).

In still another example, the home appliance 10 may access a WAN using wired communication, and may be connected to the user device 2 or the server 3 via a WAN.

When accessing a WAN using wired communication, the home appliance 10 may also act as an AP. Accordingly, the home appliance 10 may connect another home appliance to a WAN to which the server 3 is connected. In addition, another home appliance may connect the home appliance 10 to the WAN to which the server 3 is connected.

The home appliance 10 may transmit information about an operation or state to other home appliances, the user device 2, or the server 3 via the network. For example, the home appliance 10 may transmit information about an operation or state to other home appliances, the user device 2 or the server 3 upon receiving a request from the server 3, in response to an event in the home appliance 10, or periodically or in real time.

Upon receiving the information about the operation or state from the home appliance 10, the server 3 may update the stored information about the operation or state of the home appliance 10 and transmit the updated information about the operation and state of the home appliance 10 to the user device 2 via the network. Here, updating the information may include various operations in which existing information is changed, such as adding new information to the existing information, replacing the existing information with new information, and the like.

The home appliance 10 may obtain various information from other home appliances, the user device 2, or the server 3, and may provide the obtained information to a user. For example, the home appliance 10 may obtain information related to a function of the home appliance 10 (e.g., recipes, washing instructions, etc.) from the server 3 and various environmental information (e.g., weather, temperature, humidity, etc.), and may output the obtained information via a user interface.

The home appliance 10 may operate in accordance with a control command received from other home appliances, the user device 2, or the server 3. For example, the home appliance 10 may operate in accordance with a control command received from the server 3, based on a prior authorization obtained from a user to operate in accordance with the control command of the server 3 even without a user input. Here, the control command received from the server 3 may include a control command input by the user via the user device 2 or a control command based on preset conditions, but is not limited thereto.

The user device 2 may transmit information about a user to the home appliance 10 or the server 3 via the communication module. For example, the user device 2 may transmit information about a user's location, a user's health condition, a user's preference, a user's schedule, and the like to the server 3. The user device 2 may transmit information about the user to the server 3 based on the user's prior authorization.

The home appliance 10, the user device 2, or the server 3 may use techniques, such as artificial intelligence (AI) to determine a control command. For example, the server 3 may receive information about an operation or a state of the home appliance 10 or information about a user of the user device 2, process the received information using techniques, such as AI, and transmit a processing result or a control command to the home appliance 10 or the user device 2 based on the processing result.

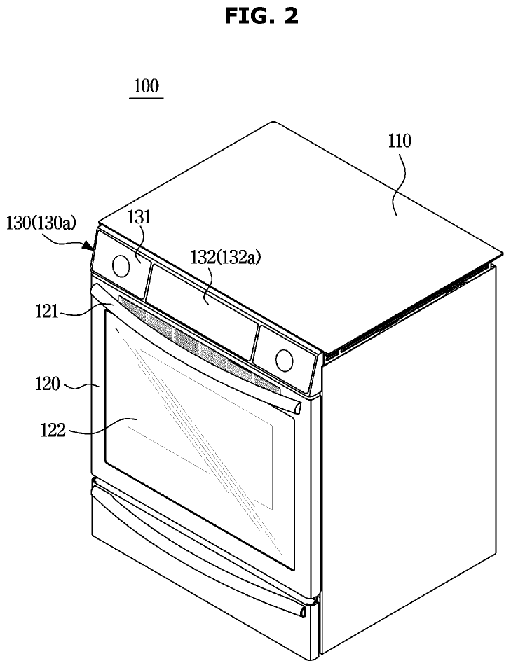

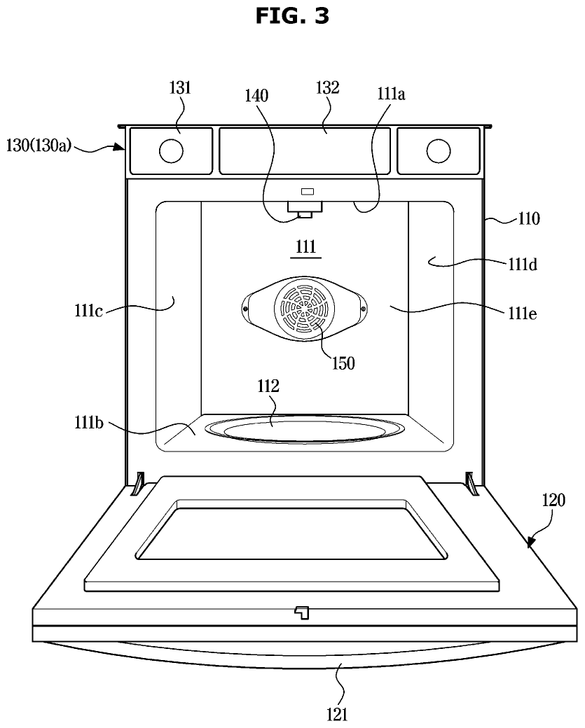

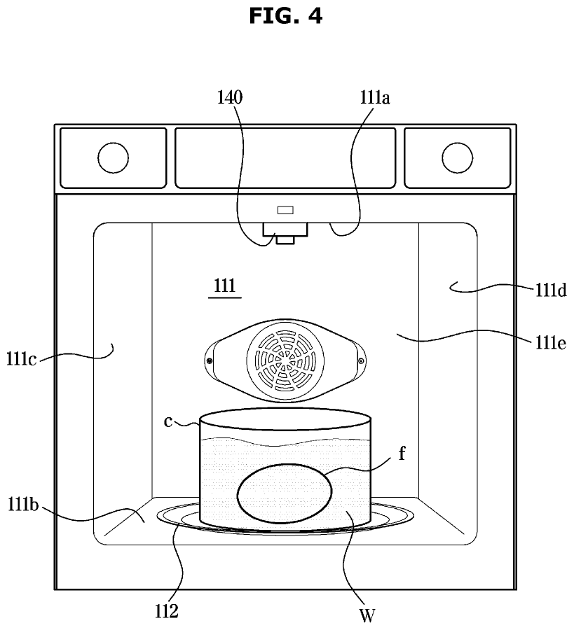

FIG. 2 is an external view of a cooking apparatus according to an embodiment. FIG. 3 is a view illustrating an example in which a door of a cooking apparatus according to an embodiment is open. FIG. 4 is a view illustrating an example arrangement of a thermal imaging sensor of a cooking apparatus according to an embodiment.

As shown in in FIG. 2 and FIG. 3, the cooking apparatus 100 includes a main body 110, a door 120, and a control panel 130.

The main body 110 forms an exterior of the cooking apparatus 100.

Inside the main body 110, a cooking chamber 111 forming a cooking space is formed.

The cooking chamber 111 may be formed in a box shape. The cooking chamber 111 may include a top surface 111a, a bottom surface 111b, a first side surface 111c, a second side surface 111d, and a rear surface 111e.

The cooking chamber 111 may include a tray 112 on which a container is placed.

The tray 112 may be positioned in a central area of the bottom surface 111b of the cooking chamber 111. The tray 112 may be rotatably positioned in the cooking chamber 111, and may be detachable from the cooking chamber 111. The tray 112 may include a rotatable turntable.

The main body 110 may include an opening through which a container containing food is put in or taken out. The opening may correspond to the front of the cooking chamber 111. The door 120 for opening and closing the cooking chamber 111 may be provided at the opening of the main body 110.

The door 120 may be positioned at the front of the main body 110 or the front of the cooking chamber 111. The door 120 may be rotatable about one side wall of the main body 110 as an axis. The one side wall of the main body 110 may be a left wall, a right wall, or a lower wall of the main body 110.

The door 120 may include a handle 121 that is held by a user.

The door 120 may include a transparent window 122. A user may visually check the inside of the cooking chamber 111 from the outside while the cooking chamber 111 is closed through the transparent window 122 of the door 120.

The control panel 130 may be positioned on the upper portion of the front of the main body 110. The control panel 130 may be positioned above the door 120. The control panel 130 may also be positioned on the left or right side of the door 120.

The control panel 130 may provide a user interface 130a for interaction between a user and the cooking apparatus.

The user interface 130a may include at least one input interface 131 and at least one output interface 132.

The at least one input interface 131 may convert sensory information received from a user into an electrical signal.

The at least one input interface 131 may include a power button, an operation button, a cooking mode selection dial (or a cooking mode selection button), a pause button, and an end button.

The at least one input interface 131 may include, for example, a keyboard, a mouse, a tact switch, a push switch, a slide switch, a toggle switch, a micro switch, a touch switch, a touch pad, a touch screen, a jog dial, and/or a microphone, and the like.

The at least one output interface 132 may visually or audibly transmit information related to the operation of the cooking apparatus 100 to a user.

For example, the at least one output interface 132 may transmit information about a cooking mode and an operation time of the cooking apparatus to a user. Information about the operation of the cooking apparatus may be output through a screen, an indicator, a voice, or the like.

The at least one output interface 132 may include, for example, a display and a speaker.

The display may be provided as a cathode ray tube (CRT), a digital light processing (DLP) panel, a plasma display panel, a liquid crystal display (LCD) panel, an electro luminescence (EL) panel, an electrophoretic display (EPD) panel, an electrochromic display (ECD) panel, a light emitting diode (LED) panel, or an organic light emitting diode (OLED) panel, but is not limited thereto.

The main body 110 may further include a thermal imaging sensor 140 for obtaining a thermal image of the cooking chamber 111.

The thermal imaging sensor 140 may detect infrared radiation emitted from the cooking chamber 111 and a container, may obtain an amount of the detected infrared radiation as an image, and may output the obtained image.

Here, the obtained image may be an image corresponding to a surface temperature of an inside of the container and a surface temperature of the cooking chamber. That is, the obtained image may include a thermal image. The thermal imaging sensor 140 may include a thermal imaging camera.

As shown in FIG. 3, water (W) and food (f) may be accommodated in a container (c). The food (f) may be accommodated inside vacuum packaging.

A capacity of the container (c) may vary. For the container (c), an amount of food and an amount of water that may be accommodated for each capacity may be determined.

The container (c) containing the food (f) and the water (W) may be placed in a first area of a plurality of areas of the cooking chamber 111. Here, the first area may be a region where the tray 112 is disposed. An area around the tray 112 may be a second area.

The thermal imaging sensor 140 may be positioned in a third area facing the first area of the areas of the cooking chamber 111.

Here, the third area may be a part of the top surface 111a of the cooking chamber. That is, the thermal imaging sensor 140 is positioned on the top surface 111a of the cooking chamber, and may be positioned in a central area, a left area, or a right area of the top surface 111a.

The thermal imaging sensor 140 may also be positioned on an upper portion of the first side surface 111c or the second side surface 111d of the cooking chamber.

The thermal imaging sensor 140 may have a field of view that includes the first area where the container is placed from among the areas of the cooking chamber 111, and may also have the second area as a field of view. That is, the thermal imaging sensor 140 may obtain thermal images of the first and second areas of the cooking chamber.

The main body 110 may further include a machine compartment (not shown).

As shown in FIG. 3, a fan 150 for discharging air or steam from the cooking chamber 111 may be disposed in the machine compartment of the main body 110.

The fan 150 may be positioned adjacent to the rear surface 111e of the cooking chamber. The fan 150 may also be positioned adjacent to the first side surface 111c, the second side surface 111d, or the top surface 111a of the cooking chamber.

An air outlet (not shown) for discharging air or steam from the cooking chamber 111 may be disposed on the top surface 111a, the first side surface 111c, the second side surface 111d, or the rear surface 111e of the cooking chamber 111. The fan 150 may be positioned adjacent to the air outlet.

The fan 150 may be positioned in the cooking chamber 111, and may also be positioned on at least one of a plurality of surfaces forming the cooking chamber 111.

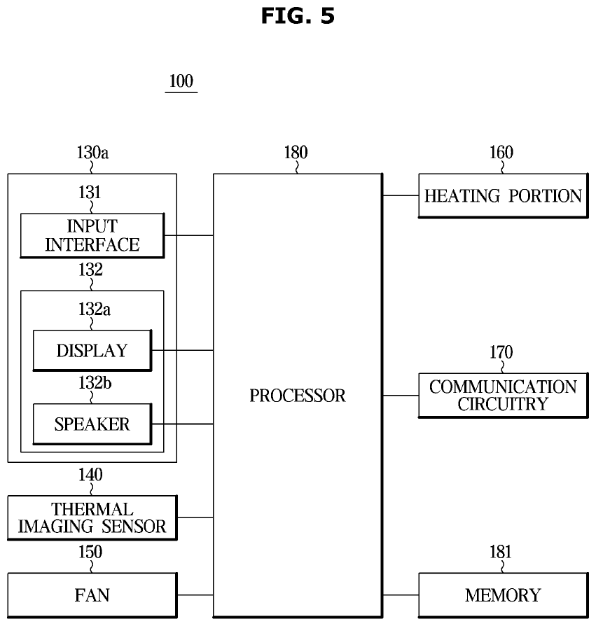

The main body 110 may further include a heating portion 160 (see FIG. 5) for heating food in the cooking chamber 111.

The heating portion 160 may be positioned in the machine compartment, or in the cooking chamber 111.

In a case where the heating portion 160 is located in the machine compartment, the heating portion 160 may be positioned adjacent to the top surface 111a of the cooking chamber 111.

In the case where the heating portion 160 is located in the machine compartment, the heating portion 160 may also be positioned adjacent to the first side surface 111c, the second side surface 111d, or the rear surface 111e of the cooking chamber 111.

The heating portion 160 may include a magnetron that generates microwaves. In this case, the cooking apparatus 100 may cook food using frictional heat generated by rotational motion of water molecules contained in the food by irradiating microwaves generated from the magnetron to the food.

The cooking apparatus 100 may include a high voltage transformer (HVT), a high voltage diode, and a high voltage capacitor for providing a high voltage to the magnetron.

The high voltage transformer may receive alternating current (AC) power from the outside and transform the AC power into a high voltage, and may include a primary coil receiving AC power and a secondary coil transforming the AC power into a high voltage. The high voltage transformer may further include a filament coil transforming the input AC power into a low voltage.

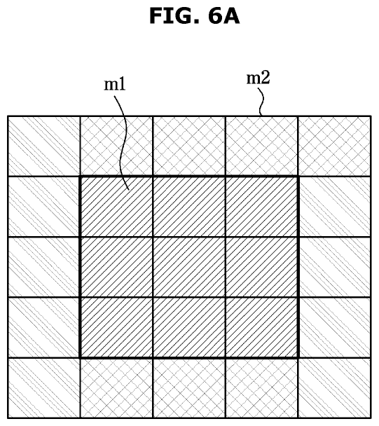

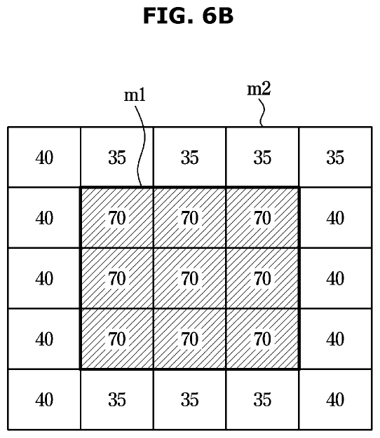

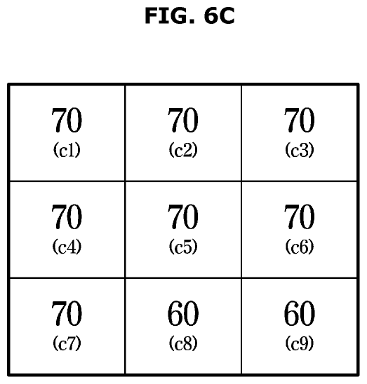

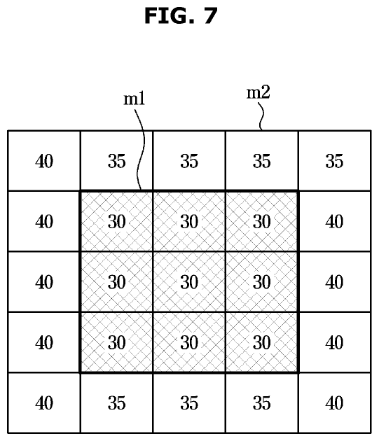

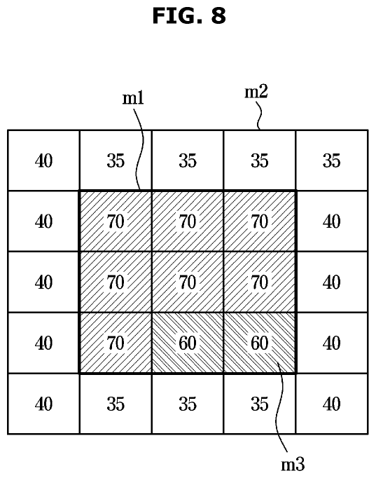

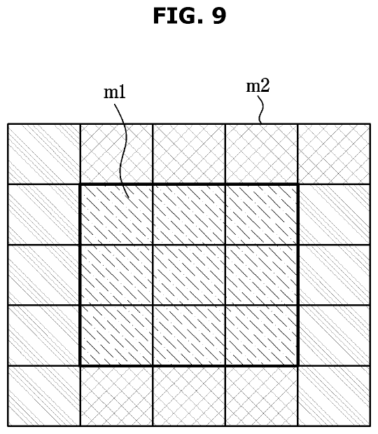

FIG. 5 is a control block diagram of a cooking apparatus according to an embodiment, which will be described with reference to FIG. 6A, FIG. 6B, FIG. 6C, FIG. 7, FIG. 8, and FIG. 9.

FIG. 6A is a view illustrating an example of a thermal image obtained by a thermal imaging sensor of a cooking apparatus according to an embodiment, FIG. 6B is a view illustrating an example of temperatures obtained by a thermal image of a cooking apparatus according to an embodiment, and FIG. 6C is a view illustrating an example of a temperature for each area of a container placed in a cooking apparatus according to an embodiment.

FIG. 7 is a view illustrating an example of temperatures obtained by a thermal image after steam is discharged from a cooking apparatus according to an embodiment, FIG. 8 is a view illustrating an example of temperatures obtained by a thermal image, when food is partially exposed above a water surface in a container after steam is discharged from a cooking apparatus according to an embodiment, and FIG. 9 is a view illustrating an example of temperatures obtained by a thermal image, when food is fully exposed above a water surface in a container after steam is discharged from a cooking apparatus according to an embodiment.

The cooking apparatus 100 includes the user interface 130a, the thermal imaging sensor 140, the fan 150, the heating portion 160, communication circuitry 170, a processor 180, and a memory 181.

The user interface 130a includes the input interface 131 for receiving a user input and the output interface 132 for outputting operation information of the cooking apparatus.

The input interface 131 may transmit input information corresponding to the user input to the processor 180.

The user input may include a cooking start command, a cooking end command, a pause command, cooking mode selection information, a target cooking temperature, and a cooking time, and the like.

The cooking mode selection information may include selection information for a sous-vide cooking mode.

The user input may also include information about a capacity of a container, an amount of water, and an amount of food.

The user input may further include information about water addition completion.

The user input may further include identification information of a user device, a communication connection command with a user device, and a communication end command with a user device.

The output interface 132 may visually and audibly output operation information and cooking preparation information in response to a control command of the processor 180 so that the information is recognized by a user.

The operation information may include information about an ongoing cooking mode, a target cooking temperature, a total cooking time, a remaining cooking time, and a device state, and may further include information about a steam discharge state and a current cooking temperature.

The device state may include a cooking-in-progress state, a cooking-paused state, and a cooking-completed state, and may further include an error state and a communication state with a user device.

The cooking preparation information may include information about a container suitable for cooking, a required container capacity, a required amount of water, and a required amount of food, and a method of placing food and water in a container.

For example, the cooking preparation information may include sous-vide cooking preparation information corresponding to a sous-vide cooking mode.

The output interface 132 may include at least one of a display 132a for displaying operation information and cooking preparation information of the cooking apparatus, or a speaker 132b for outputting operation information and cooking preparation information of the cooking apparatus as sound or voice.

The thermal imaging sensor 140 obtains a thermal image of the cooking chamber, and transmits the obtained thermal image to the processor 180.

The thermal image of the cooking chamber may include thermal images of the inside and outside of the container. The outside of the container may include a surface on which the container is placed, from among surfaces of the cooking chamber.

That is, the thermal imaging sensor 140 may detect the amount of infrared radiation of the inside and outside of the container, and convert the detected amount of infrared radiation to a color corresponding to the detected amount of infrared radiation to obtain the thermal image.

When obtaining the thermal image, the thermal imaging sensor 140 may assign a predetermined color to each detected amount of infrared radiation.

The fan 150 may rotate or stop in response to a control command of the processor 180. A rotation speed of the fan 150 rotating in response to the control command of the processor 180 may be constant.

The fan 150 may include a motor and blades rotated by the motor. The fan 150 may be a centrifugal fan or a turbo fan that draws in air and discharges air in a radial direction.

One or two or more fans 150 may be provided. Two or more fans 150 may be vertically disposed in the machine compartment of the cooking apparatus 1, or may be horizontally disposed in the machine compartment.

The heating portion 160 may receive power from a power supply (not shown), and convert the received power into energy for cooking food.

The heating portion 160 may include a magnetron.

The heating portion 160 may be turned on or off in response to a control command of the processor 180, and an output of the heating portion 160 may be adjusted. That is, while the heating portion 70 is in an ON state, the output of the heating portion 160 may increase or decrease in response to the control command of the processor 180.

The heating portion 160 may include one or two or more heaters, and may further include a steam generator that generates steam.

The processor 180 may perform overall control of the operation of the cooking apparatus.

The processor 180 may control various components of the cooking apparatus according to a user input received through the input interface 131, and may control the output interface 132 to output operation information corresponding to the control of the various components.

The processor 180 may control the heating portion 160 based on a cooking time and a cooking start command received through the input interface 131.

In a case where the heating portion is a magnetron, based on receiving a cooking time and a cooking start command without cooking mode selection information, the processor 180 may control an output of the magnetron to a reference output, and may operate the magnetron for the received cooking time.

The processor 180 may control an output of the heating portion 160 and an operation time of the heating portion 160, based on receiving a target cooking temperature, a cooking time, and a cooking start command from the input interface 131.

The processor 180 may control an operation of at least one of the heating portion 160 or the fan 150 to stop, based on a cooking pause command received through the input interface 131. The processor 180 may control an operation of at least one of the heating portion 160 or the fan 150 to stop based on a cooking end command received through the input interface 131.

The processor 180 may control the heater, steam generator, or magnetron based on the cooking mode selection information received through the input interface 131.

The processor 180 may also control the output interface 132 to output cooking preparation information based on the cooking mode selection information received through the input interface 131.

The processor 180 may determine whether a cooking mode selected by a user is a sous-vide cooking mode based on the cooking mode selection information received through the input interface 131.

The processor 180 may control the output interface 132 to output cooking preparation information, based on determining that the cooking mode selected by the user is the sous-vide cooking mode.

Based on determining that the cooking mode selected by the user is the sous-vide cooking mode, the processor 180 may control the output of the heating portion 160 based on the target cooking temperature received through the input interface 131, and may control the operation time of the heating portion 160 based on the cooking time received through the input interface 131.

In response to a target cooking temperature and a cooking time for sous-vide cooking not being received through the input interface 131, the processor 180 may also control an output and an operation time of the heating portion 160 based on a preset sous-vide cooking time and a preset sous-vide cooking temperature.

The heating portion 160 operated for sous-vide cooking may be a magnetron.

The processor 180 may receive a thermal image from the thermal imaging sensor 140 during execution of the sous-vide cooking mode. The thermal image received from the thermal imaging sensor 140 may include a thermal image of the cooking chamber 111.

The processor 180 may obtain shape information based on the thermal image received from the thermal imaging sensor 140, and obtain a thermal image of the container based on the obtained shape information. The processor 180 may obtain a thermal image of an inner area of the container from the thermal image of the container.

The processor 180 may also recognize the thermal image of the container from the received thermal image based on pre-stored position information of the container. The pre-stored position information of the container may be position information corresponding to position information of a tray.

The processor 180 may obtain, as a thermal image of an outer area of the container, a thermal image of an area excluding the thermal image of the inner area of the container from the received thermal image.

As shown in FIG. 6A, the processor 180 may obtain a thermal image m1 of the inner area of the container and a thermal image m2 of the outer area of the container from the received thermal image.

The thermal image m2 of the outer area of the container may include a thermal image of a surface of the cooking chamber 111. The thermal image m2 of the outer area of the container may include a thermal image of a surface of an area around the tray 112 from among the surfaces of the cooking chamber 111.

As shown in FIG. 6B, the processor 180 may obtain a temperature of the inner area of the container and a temperature of the outer area of the container based on the thermal image m1 of the inner area of the container and the thermal image m2 of the outer area of the container.

The temperature of the inner area of the container may be a surface temperature of the inner area of the container.

The surface temperature of the inner area of the container may include a surface temperature of water, a surface temperature of food, and a surface temperature of water and a surface temperature of food.

The obtained temperature of the inner area of the container may be one or two or more temperature values.

When the obtained temperature of the inner area of the container is a single temperature value, this indicates that the temperatures of the inner area of the container are all the same, and that the food is submerged in the water of the container, or that only the food is fully exposed above the water surface of the container without the water surface being exposed.

When the obtained temperature of the inner area of the container is two or more temperature values, this indicates that temperatures of a portion of the inner areas of the container are different from temperatures of the remaining areas, and that the food is partially exposed above the water surface of the container.

The obtained temperature of the outer area of the container may be one or two or more temperature values.

The temperature of the outer area of the container may be a surface temperature of the outer area of the container.

The outer area of the container may be an area of the cooking chamber excluding the container.

The temperatures of the outer area of the container may be all the same, and temperatures of a portion of the outer areas of the container may be different from temperatures of the remaining areas.

In a case where there are two or more obtained temperatures of the inner areas of the container, the processor 180 may obtain any one of the plurality of temperatures of the inner areas of the container as a representative temperature, and select the obtained representative temperature as the temperature of the inner area of the container to control the heating portion 160.

As an example, the processor 180 may obtain a maximum temperature among the obtained temperatures of the inner areas of the container as a representative temperature of the temperatures of the inner areas of the container. Referring to FIG. 6C, 70° C., which is the maximum temperature among the obtained temperatures of the inner areas of the container, may be obtained as the representative temperature of the temperatures of the inner areas of the container.

As another example, the processor 180 may obtain a minimum temperature among the obtained temperatures of the inner areas of the container as a representative temperature of the temperatures of the inner areas of the container. Referring to FIG. 6C, 60° C., which is the minimum temperature among the obtained temperatures of the inner areas of the container, may be obtained as the representative temperature of the temperatures of the inner areas of the container.

As still another example, the processor 180 may obtain an average temperature of the obtained temperatures of the inner areas of the container as a representative temperature of surface temperatures of the food. Referring to FIG. 6C, the processor 180 may divide the thermal image of the food into a plurality of cells (c1-c9) of the same size, obtain a temperature of each of the plurality of divided cells (c1-c9), obtain an average temperature (67.8° C.) based on the obtained temperatures of the cells, and obtain the obtained average temperature as a representative temperature of the temperatures of the inner areas of the container.

In a case where there are two or more obtained temperatures of the outer areas of the container, the processor 180 may select one of the two or more temperatures of the outer areas of the container as a representative temperature of the outer areas of the container. The processor 180 may select a maximum temperature, a minimum temperature, or an average temperature of the two or more temperatures of the outer areas of the container as the representative temperature of the outer areas of the container.

Based on the obtained temperatures of a partial area of the container being different from temperatures of the remaining areas, the processor 180 may obtain a cooking operation time. The processor 180 may control the output interface 132 to output a cooking abnormality notification, based on the obtained cooking operation time being less than a reference time.

Here, the obtained partial area and the remaining areas of the container may be the inner area of the container.

The processor 180 may control the communication circuitry 170 to transmit the cooking abnormality notification to a user device.

The processor 180 may determine whether to discharge steam or whether water is insufficient, based on the obtained cooking operation time being greater than or equal to the reference time.

Here, the reference time may be a starting point at which steam is generated.

The reference time may be a time when an amount of generated steam reaches a level that deteriorates the accuracy of a thermal image.

The starting point at which steam is generated may be determined based on an amount of water and an internal temperature of the container. The amount of steam may be determined based on the amount of water, the internal temperature of the container, and the cooking operation time. Based on the above, the reference time may be determined.

Here, the cooking operation time may correspond to a time for heating water.

Based on receiving information about the amount of water through the input interface 131, the processor 180 may also obtain the reference time corresponding to the received amount of water, and compare the obtained reference time with the obtained cooking operation time, thereby determining whether a cooking abnormality exists.

In a case where steam is not generated in the cooking chamber 111, the thermal image of the inner area of the container obtained by the thermal imaging sensor 140 has high accuracy. Accordingly, as time passes, the temperature of the inner area of the container may increase, or remain constant.

In a case where a small or large amount of steam is generated in the cooking chamber, the accuracy for the thermal image of the inner area of the container obtained by the thermal imaging sensor 140 is reduced. Accordingly, the temperature of the inner area of the container may change rapidly as time passes.

As shown in FIG. 7, in a case where a large amount of steam is generated in the cooking chamber 111, the temperature of the inner area of the container obtained by the thermal image may decrease rapidly.

For example, in a case where a large amount of steam is generated in the cooking chamber 111, the temperature of the inner area of the container obtained by the thermal image may decrease rapidly from 70° C. to 30° C.

Based on the above, the processor 180 may monitor a temperature change in the inner area of the container based on the obtained temperature of the inner area of the container, and may control the fan 150 based on a change value of the monitored temperature of the inner area of the container.

Based on the temperature change value of the inner area of the container being greater than or equal to a reference value, the processor 180 may control the fan 150 to discharge steam from the cooking chamber 111 to the outside.

The processor 180 may control an output of the heating portion 160 to increase based on the fan being controlled to turn on. That is, the processor 180 may control the output of the heating portion 160 to an output higher than a reference output.

The processor 180 may obtain a temperature (hereinafter, a first temperature) of the inner area of the container immediately before controlling the fan to turn on, may monitor the temperature of the inner area of the container based on a thermal image while the fan is turned on, and may control the fan 150 to be turned off based on the monitored temperature (i.e., a second temperature) reaching the first temperature, which is described in detail with reference to the table below.

TABLE 1

| | Cooking operation time | | | | | | | |
|---|---|---|---|---|---|---|---|---|
| | m10 s | m11 s | m12 s | m13 s | m14 s | m15 s | m16 s | m17 s |
| Temperature | 40 | 45 | 46 | 42 | 42 | 44 | 46 | 47 |
| of container | | | | | | | | |
| Operation of | | | | on | on | on | off | |
| fan | | | | | | | | |

When the temperature of the inner area of the container drops rapidly from 46 degrees to 42 degrees, the processor 180 may determine that steam discharge is required and control the fan 150 to be turned on. In addition, the processor 180 may obtain 46° C., which is the temperature of the container immediately before controlling the fan to turn on, as the first temperature. The processor 180 may monitor the temperature of the inner area of the container based on the thermal image while the fan 150 is turned on, and may control the fan 150 to be turned off based on the second temperature of the inner area of the container reaching 46° C. during monitoring. The processor 180 may control the output of the heating portion 160 to be restored to the reference output, based on the fan 150 being turned off.

The processor 180 may obtain a maintenance time during which the temperature change value of the inner area of the container is maintained, based on the temperature change value of the inner area of the container being greater than or equal to a reference value. Based on the obtained maintenance time being greater than or equal to a defined time, the processor 180 may control the fan 150 to be turned on, and based on the obtained maintenance time being less than the reference time, may maintain the fan 150 in an OFF state.

In a case where the obtained maintenance time is less than the reference time, the processor 180 may recognize it as a temporary temperature change, and maintain the fan in an OFF state.

In a case where water was insufficient in the container before sous-vide cooking or water in the container decreases due to generation of steam, the food may be partially exposed above the water surface of the container. In this case, colors of a portion of the inner areas of the container may be different from colors of the remaining areas.

As shown in FIG. 8, when the food is exposed above the water surface of the container, temperatures of portions m3 of the inner areas of the container may be different from the temperatures of the remaining areas.

Based on the temperatures of portions of the inner areas of the container being different from the temperatures of the remaining areas, the processor 180 may determine a water shortage, may control the output interface 132 to output a water shortage notification based on determining the water shortage, and may control the communication circuitry 170 to transmit the water shortage notification to the user device 2.

When water in the container decreases due to generation of steam, the thermal imaging sensor 140 may obtain, as a thermal image of the container, a thermal image including only food not water. In this case, a change in the color of the thermal image of the inner area of the container obtained by the thermal imaging sensor 140 may be different from a change in the color of the thermal image of the outer area of the container. That is, a temperature change value of the inner area of the container may be different from a temperature change value of the outer area of the container.

Comparing FIG. 6A and FIG. 9, in a case where only the thermal image of the food is obtained as a thermal image of the container after steam discharge, colors of thermal images of the outer area m2 of the container before and after steam discharge may be the same or similar, but colors of thermal images of the inner area of the container before and after steam discharge may be different from each other.

Based on the above, the processor 180 may obtain a first internal temperature of the inner area of the container and a first external temperature of the outer area of the container corresponding to the thermal image before the fan 150 is turned on, and may obtain a second internal temperature of the inner area of the container and a second external temperature of the outer area of the container based on a thermal image obtained after the fan 150 is turned off.

The processor 180 may obtain the temperature change value of the inner area of the container by comparing the first internal temperature and the second internal temperature, and may obtain the temperature change value of the outer area of the container by comparing the first external temperature and the second external temperature. The processor 180 may determine a water shortage based on the obtained temperature change value of the inner area of the container being greater than the temperature change value of the outer area of the container, and may control the communication circuitry 170 to transmit a water shortage notification to the user device 2.

The processor 180 may also identify a home appliance used by a user from among home appliances capable of communicating within a home, and control the communication circuitry 170 to transmit the water shortage notification to the identified home appliance.

For example, the processor 180 may control the communication circuitry 170 to transmit the water shortage notification to a television based on identifying that a user is using the television.

The processor 180 may control the output interface 132 to output the water shortage notification.

The processor 180 may monitor a temperature change in the inner area of the container until information about water addition is received through the input interface 131, and may control the fan to be turned on or off based on the monitored temperature change in the inner area of the container.

The processor may control the output of the heating portion to increase based on the fan being controlled to turn on, and control the output of the heating portion to be restored based on the fan being controlled to turn off.

The processor 180 may also control the output of the heating portion to increase for a preset time based on receiving the information about water addition through the input interface 131.

The processor 180 may control the heating portion 160 to be repeatedly turned on/off or control the output of the heating portion 160 to decrease so that an internal temperature of the container is maintained at a target cooking temperature.

The processor 180 may control the heating portion 160 to be turned off based on the cooking operation time reaching the cooking time received through the input interface 131.

The processor 180 may control the output interface 132 to output information about end of sous-vide cooking, and control the communication circuitry 170 to transmit a command to end the sous-vide cooking to the user device 2.

Here, the user device may be a user device possessed by a pre-registered user.

In controlling the output portion, the processor 180 may control at least one of the display or the speaker.

The processor 180 may perform the aforementioned operations using data stored in the memory 181.

The processor 180 may include hardware such as a central processing unit (CPU) and memory, and software such as a control program. For example, the processor 180 may include at least one memory for storing data in the form of an algorithm or a program for controlling the operation of components in the cooking apparatus, and one or more processor chips or one or more processing cores for performing the aforementioned operations using the data stored in the at least one memory.

The processor 180 may include a separate neural processing unit (NPU) that performs the operation of an artificial intelligence model, and may include a graphic processing unit (GPU), and the like.

The memory 181 may store information about a temperature for each color forming a thermal image.

The memory 181 may store information about a reference time for determining whether steam may be generated, a defined time for determining whether a temperature change in the container is temporary, and a reference value for determining steam discharge.

The memory 181 may store information about a temperature of the container at each time during a sous-vide cooking mode. The temperature of the container at each time may be an internal temperature of the container at each time.

The memory 181 may store identification information of the user device.

The memory 181 may include one or more memory chips or one or more memory blocks.

The memory 181 may store data for an algorithm or a program that reproduces the algorithm for controlling the operation of components in the cooking apparatus.

The memory 181 and the processor 180 may be implemented as separate chips. Alternatively, the memory 181 and the processor 180 may be implemented as a single chip.

The memory 181 may be implemented as at least one of a non-volatile memory device, such as a cache, read only memory (ROM), programmable ROM (PROM), erasable programmable ROM (EPROM), electrically erasable programmable ROM (EEPROM), and flash memory, or a volatile memory device, such as random access memory (RAM), or a storage medium such as a hard disk drive (HDD) and CD-ROM, but is not limited thereto.

At least one component may be added or omitted corresponding to the performance of the components of the cooking apparatus shown in FIG. 5. In addition, it will be easily understood by those skilled in the art that the mutual positions of the components may be modified corresponding to the performance or structure of the system.

Meanwhile, each component shown in FIG. 5 may refer to software and/or hardware components such as a field programmable gate array (FPGA) and an application specific integrated circuit (ASIC).

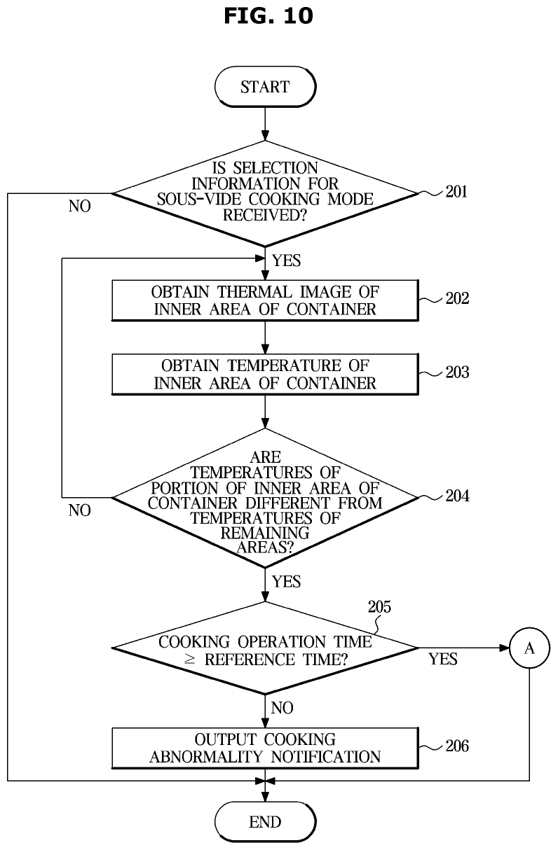

FIG. 10 is a flowchart illustrating a method for controlling a cooking apparatus according to an embodiment.

The cooking apparatus may control the output interface 132 to output cooking preparation information, based on receiving a sous-vide cooking mode through the input interface (201).

For example, the cooking apparatus may display guide information about an amount of water and an amount of food for each capacity of a container through the display 132a, or may output guide information as a voice through the speaker 132b.

The cooking apparatus may also display a sample image of the container containing water and food through the display 132a.

The cooking apparatus may also display request information requesting an input of a cooking time, a target cooking temperature, a capacity of the container, an amount of water, and an amount of food through the display 132a.

Based on receiving cooking information for sous-vide cooking through the input portion, the cooking apparatus may also store the received cooking information, and control the heating portion and the fan based on the stored cooking information.

For example, the cooking apparatus may control an output of the heating portion 160 based on the target cooking temperature received through the input interface 131, and control an operation time of the heating portion 160 based on the cooking time received through the input interface 131.

In response to a target cooking temperature and a cooking time for sous-vide cooking not being received through the input interface 131, the cooking apparatus may also control an output and an operation time of the heating portion 160 based on a preset sous-vide cooking time and a preset sous-vide cooking temperature.

The heating portion 160 operated for sous-vide cooking may be a magnetron.

The cooking apparatus may control an output of the heating portion based on receiving a cooking start command, and may obtain a thermal image of the cooking chamber using the thermal imaging sensor 140 (202).

Controlling the output of the heating portion may include controlling the output of the heating portion to a reference output.

The cooking start command may also be received together with selection information for a sous-vide cooking mode. In this case, the cooking apparatus may obtain the thermal image of the cooking chamber based on receiving the selection information for the sous-vide cooking mode and the cooking start command.

The cooking apparatus may obtain shape information based on the obtained thermal image, and obtain the thermal image of the container based on the obtained shape information.

The cooking apparatus may also obtain a thermal image of the container through learning.

The cooking apparatus may obtain, as a thermal image of an outer area of the container, a thermal image of an area excluding the thermal image of the container from the received thermal image. Here, the thermal image of the container may include a thermal image of an inner area of the container.

That is, the cooking apparatus may obtain the thermal image of the inner area of the container and the thermal image of the outer area of the container from the received thermal image.

The cooking apparatus may obtain a temperature of the inner area of the container based on the thermal image of the inner area of the container (203).

The temperature of the inner area of the container may be a surface temperature of the inner area of the container.

The surface temperature of the inner area of the container may include a surface temperature of water, a surface temperature of food, and a surface temperature of water and a surface temperature of food.

The obtained temperature of the inner area of the container may be one or two or more temperature values.

When the obtained temperature of the inner area of the container is two or more temperature values, this indicates that temperatures of a portion of the inner areas of the container are different from temperatures of the remaining areas.

That is, the cooking apparatus determines whether the obtained temperatures of a portion of the inner areas of the container are different from the temperatures of the remaining areas (204).

The cooking apparatus obtains a cooking operation time based on the obtained temperatures of a portion of the inner areas of the container being different from the temperatures of the remaining areas, and determines whether the obtained cooking operation time is greater than or equal to a reference time (205).

The cooking operation time may include a period of time from a point at which the cooking start command is received to a point at which the temperatures of the portion of the inner areas become different from the temperatures of the remaining areas.

The reference time is a period of time during which steam may be generated, and may be information obtained and stored by a test.

The cooking apparatus may control the output interface 132 to output a cooking abnormality notification, based on determining that the obtained cooking operation time is less than the reference time (206).

The cooking apparatus may also transmit the cooking abnormality notification to a pre-registered user device.

The cooking apparatus may determine whether to discharge steam or whether water is insufficient, based on determining that the obtained cooking operation time is greater than or equal to the reference time.

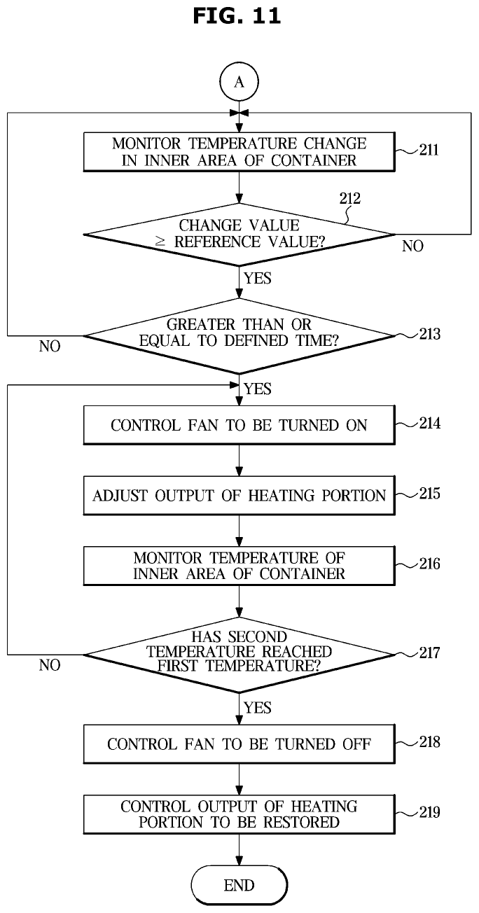

FIG. 11 is a flowchart illustrating a method for controlling a fan and a heating portion of a cooking apparatus according to an embodiment.

The cooking apparatus obtains a temperature of the container based on the thermal image obtained by the thermal imaging sensor, and monitors the obtained temperature of the container (211). Here, the temperature of the container may be a temperature of the inner area of the container.

When monitoring the temperature of the inner area of the container, the cooking apparatus may monitor a temperature change in the inner area of the container based on an elapse of the cooking operation time, and may obtain a temperature change value of the inner area of the container based on the monitored temperature change in the inner area of the container.

The cooking apparatus may determine whether the temperature change value of the inner area of the container is greater than or equal to a reference value (212).

Determining whether the temperature change value of the inner area of the container is greater than or equal to the reference value is for determining whether to discharge steam from the cooking chamber.

Based on determining that the temperature change value of the inner area of the container is greater than or equal to the reference value, the cooking apparatus obtains a maintenance time during which the temperature change value of the inner area of the container is maintained to be greater than or equal to the reference value, and determines whether the obtained maintenance time is greater than or equal to a defined time (213).

That is, the cooking apparatus compares the obtained maintenance time and the defined time to determine whether the temperature change in the inner area of the container is temporary.

The cooking apparatus may maintain an OFF state of the fan based on determining that the obtained maintenance time is less than the defined time.

The cooking apparatus may control the fan 150 to be turned on, based on determining that the obtained maintenance time is greater than or equal to the defined time, thereby discharging steam from the cooking chamber to the outside (214).

In order to prevent the temperature of the cooking chamber and the temperature of the food from being lowered due to steam discharge, the cooking apparatus may adjust an output of the heating portion 160 while the fan 150 is turned on (215). Adjusting the output of the heating portion may include adjusting the output of the heating portion to be higher than the reference output.

The cooking apparatus may obtain a temperature (hereinafter, a first temperature) of the inner area of the container immediately before controlling the fan 150 to turn on, and may store the obtained first temperature.

The cooking apparatus may monitor a temperature of the inner area of the container based on the thermal image obtained by the thermal imaging sensor while the fan 150 is turned on (216), and may determine whether the monitored temperature (i.e., a second temperature) has reached the first temperature (217).

The cooking apparatus may control the fan 150 to be turned off (218), based on determining that the second temperature has reached the first temperature.

The cooking apparatus may control the output of the heating portion 160 to be restored to the reference output (219), based on the fan being controlled to turn off.

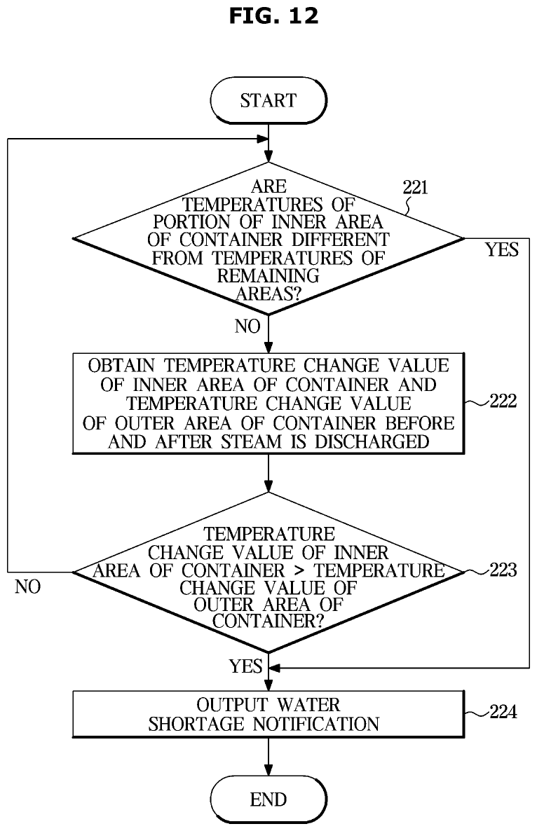

FIG. 12 is a flowchart illustrating operations of determining whether water is insufficient in a cooking apparatus according to an embodiment.

After discharging steam, the cooking apparatus may determine whether temperatures of a portion of the inner areas of the container are different from temperatures of the remaining areas (221), and may determine a water shortage based on the temperatures of a portion of the inner areas of the container being different from the temperatures of the remaining areas.

Based on the temperatures of the inner area of the container being all the same, the cooking apparatus may obtain a first internal temperature of the inner area of the container and a first external temperature of the outer area of the container corresponding to the thermal image before the fan 150 is turned on, and may obtain a second internal temperature of the inner area of the container and a second external temperature of the outer area of the container based on a thermal image obtained after the fan 150 is turned off.

The cooking apparatus may obtain a temperature change value of the inner area of the container by comparing the first internal temperature and the second internal temperature, and may obtain a temperature change value of the outer area of the container by comparing the first external temperature and the second external temperature (222).

The cooking apparatus may determine whether the obtained temperature change value of the inner area of the container is greater than the temperature change value of the outer area of the container (223), and may determine a water shortage of the container based on the obtained temperature change value of the inner area of the container being greater than the temperature change value of the outer area of the container.

The cooking apparatus may control the output interface 132 to output a water shortage notification based on determining the water shortage, and control the communication circuitry 170 to transmit the water shortage notification to the user device 2 (224).

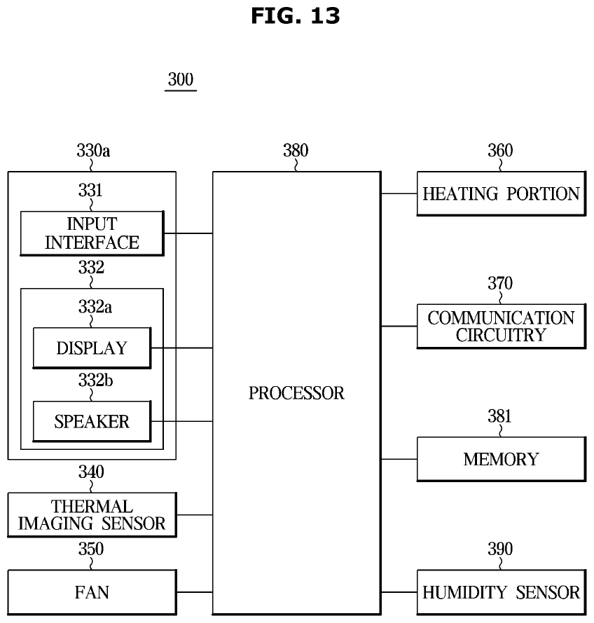

FIG. 13 is a control block diagram of a cooking apparatus according to another embodiment.

A cooking apparatus 300 includes a user interface 330a, a thermal imaging sensor 340, a fan 350, a heating portion 360, a processor 380, and a memory 381, and may further include a humidity sensor 390. The user interface 330a may include at least one input interface 331 and at least one output interface 332. The at least one output interface 332 may include, for example, a display 332a and a speaker 332b.

The user interface 330a, the thermal imaging sensor 340, the fan 350, and the heating portion 360 of FIG. 13 are the same as the user interface 130a, the thermal imaging sensor 140, the fan 150, and the heating portion 160 of FIG. 5, and thus descriptions thereof will be omitted.

The humidity sensor 390 may detect humidity in the cooking chamber and transmit the detected humidity to the processor 380.

The processor 380 may control the fan 350 to be turned on, based on determining that the humidity of the cooking chamber detected by the humidity sensor 390 is greater than or equal to a reference humidity, and control the fan 350 to be turned off based on determining that the humidity of the cooking chamber detected by the humidity sensor 390 is less than the reference humidity.

The processor 380 may control an output of the heating portion 360 to increase while the fan 150 is turned on.

The processor 380 may control the output of the heating portion 360 to be restored, based on the fan being controlled to turn off.

After discharging steam, the processor 380 may obtain a temperature of an inner area of the container based on a thermal image received from the thermal imaging sensor 340, may determine whether temperatures of a portion of the inner areas of the container are different from temperatures of the remaining areas, and may determine a water shortage based on the temperatures of a portion of the inner areas of the container being different from the temperatures of the remaining areas.

The processor 380 may control an output interface 332 to output a water shortage notification based on determining the water shortage of the container, and control the communication circuitry 370 to transmit the water shortage notification to a user device.

The memory 381 may further store information about the reference humidity.

Meanwhile, the disclosed embodiments may be implemented in the form of a recording medium that stores instructions executable by a computer. The instructions may be stored in the form of program codes, and when executed by a processor, the instructions may create a program module to perform operations of the disclosed embodiments. The recording medium may be implemented as a computer-readable recording medium.

The computer-readable recording medium may include all kinds of recording media storing instructions that can be interpreted by a computer. For example, the computer-readable recording medium may be read only memory (ROM), random access memory (RAM), a magnetic tape, a magnetic disc, a flash memory, an optical data storage device, etc.

Although embodiments of the disclosure have been described with reference to the accompanying drawings, a person having ordinary skilled in the art will appreciate that other specific modifications may be easily made without departing from the technical spirit or essential features of the disclosure. Therefore, the foregoing embodiments should be regarded as illustrative rather than limiting in all embodiments.

What is claimed is:

1. A cooking apparatus, comprising:
a cooking chamber configured to accommodate a container containing food and water;
a thermal imaging sensor configured to obtain a thermal image of the container accommodated in the cooking chamber;
a heating portion configured to heat the food;
a fan configured to discharge steam from the cooking chamber; and
a processor configured to identify a temperature change of the container based on the thermal image of the container, and control at least one of the fan and the heating portion based on the identified temperature change of the container.

2. The cooking apparatus of claim 1, wherein the thermal image of the container includes at least one of a thermal image of a surface of the water contained in the container or a thermal image of a surface of the food contained in the container.

3. The cooking apparatus of claim 1, wherein the processor is further configured to:
control the fan to be turned on based on the identified temperature change being greater than or equal to a reference value.

4. The cooking apparatus of claim 1, wherein the processor is further configured to:
based on identifying that the identified temperature change being greater than or equal to a reference value, is maintained during a defined time,
control the fan to be turned on, and
control the heating portion to increase an output of the heating portion based on the fan being turned on.

5. The cooking apparatus of claim 3, wherein the processor is further configured to:
obtain a first temperature of the container immediately before the fan is turned on,
obtain a second temperature of the container while the fan is turned on, and
control the fan to be turned off based on the obtained second temperature reaching the first temperature.

6. The cooking apparatus of claim 5, wherein the processor is further configured to:
control the output of the heating portion, which has been increased based on the fan being turned on, to be restored based on the fan being turned off.

7. The cooking apparatus of claim 1,
wherein the processor is further configured to:
obtain a temperature of each of a plurality of areas of the container, and
identify a water shortage, based on temperatures of a portion of the plurality of areas being different from temperatures of remaining areas.

8. The cooking apparatus of claim 7,
wherein the processor is configured to:
identify a cooking operation time which is a time duration from a time of turning-on the heating portion to a time identifying that the temperatures of the portion of the plurality of areas being different from the temperatures of the remaining areas, and
based on the identified cooking operation time being less than a reference time, identify an occurrence of abnormal state, and
wherein the reference time is an expected time duration from the time of turning-on the heating portion to a time at which the steam begins to form.

9. The cooking apparatus of claim 7, further comprising:
at least one of an output portion and communication circuitry configured to communicate with an external apparatus, and
wherein the processor is further configured to: control the output portion to output corresponding to the water shortage, or control the communication circuitry to transmit signal corresponding to the water shortage to the external apparatus.

10. The cooking apparatus of claim 1,
wherein the processor is further configured to:
identify a water shortage based on a difference between a change of the temperature of an area of the container and a remaining area which is not the area of the container in the obtained thermal image.

11. A method for controlling a cooking apparatus including a cooking chamber, a thermal imaging sensor, a heating portion, a fan and a processor, the method comprising:
identifying a temperature change of a container accommodated in the cooking chamber based on a thermal image obtained by the thermal imaging sensor, the container containing food and water; and
controlling at least one of the fan and the heating portion based on the identified temperature change in the container.

12. The method of claim 11,
wherein the thermal image of the container includes at least one of a thermal image of a surface of the water contained in the container or a thermal image of a surface of the food contained in the container.

13. The method of claim 11, wherein the controlling of the fan comprises: controlling the fan to be turned on based on the identified temperature change being greater than or equal to a reference value.

14. The method of claim 11, wherein the controlling of the fan comprises:
controlling the fan to be turned on, based on identifying that the identified temperature change being greater than or equal to the reference value, is maintained during a defined time, and
controlling the fan to be turned off, is not maintained during the defined time,
wherein the controlling of the heating portion comprises controlling the heating portion to increase an output of the heating portion based on the fan being turned on.

15. The method of claim 13, wherein the controlling of the fan comprises:
obtaining a first temperature of the container immediately before the fan is turned on,
obtaining a second temperature of the container while the fan is turned on, and
controlling the fan to be turned off based on the obtained second temperature reaching the first temperature.

16. The method of claim 15, wherein the controlling of the heating portion comprises:
controlling an output of the heating portion, which has been increased based on the fan being turned on, to be restored based on the fan being turned off.

17. The method of claim 11, further comprising:
obtaining a temperature of each of a plurality of areas of the container, and
identifying a water shortage, based on temperatures of a portion of the plurality of areas being different from temperatures of remaining areas.

18. The method of claim 17, further comprising:
identifying a cooking operation time which is a time duration from a time of turning-on the heating portion to a time identifying that the temperatures of the portion of the plurality of areas being different from the temperatures of the remaining areas, and
based on the identified cooking operation time being less than a reference time, identifying an occurrence of abnormal state, and
wherein the reference time is an expected time duration from the time of turning-on the heating portion to a time at which the steam begins to form.

19. The method of claim 17, further comprising:
controlling an output portion to output corresponding to the water shortage, or controlling communication circuitry to transmit signal corresponding to the water shortage to an external apparatus.

20. The method of claim 11, further comprising:
identifying a water shortage based on a difference between a change of the temperature of an area of the container and a remaining area which is not the area of the container in the obtained thermal image.
